(19) United States
(12) Patent Application Publication
(10) Pub. No.: US 2003/0135435 A1
(43) Pub. Date: Jul. 17, 2003

(54) E-DRAFT collection

(76) Inventor: Amos Aharoni, Tel Aviv (IL)

Correspondence Address: THEODORE JAY, SUITE 600, 16 N CHATSWORTH AVE., LARCHMONT, NY, 10538, US

(21) Appl. No.: 10/103,532

(22) Filed: Mar. 21, 2002

Related U.S. Application Data
(63) Continuation-in-part of application No. 10/047,157, filed on Jan. 15, 2002.

(51) Int. Cl. G06F 17/60

(52) U.S. Cl. 705/35

(57) ABSTRACT

A new financing arrangement employing a transaction record and processes for using it, controlled and financed by a financial organization that offers financial advantages for both exporters and importers of goods/services.

### CROSS REFERENCE TO CO-PENDING APPLICATION

The present application is a continuation in part of an application entitled “E-DRAFT Corporate L/C”, Ser. No. 10/047,157, filed Jan. 15, 2002.

### BACKGROUND OF THE INVENTION

A letter of credit is a document issued by a bank stating its commitment to pay someone [supplier/exporter/seller/beneficiary] a stated amount of money on behalf of a buyer [importer] so long as the seller meets very specific terms and conditions. The banks handling the transaction deal in documents as opposed to goods.

### OBJECT OF THE INVENTION

The E-DRAFT CORPORATE L/C application provides a new financing instrument, and processes for using it, controlled and financed by a financial organization or financial institution that offers for both exporters and importers of goods/services, who wish to deal with each other, substantially the same advantages obtainable by them using a letter of credit but at lower cost. The organization is not a bank. All transactions are processed partially or entirely electronically.

The present invention is directed toward a modification of the aforementioned application, which reduces the number, and content of the documents required by exporters and importers and reduces their cost.

### SUMMARY OF THE INVENTION

An E-DRAFT is an financial instrument, a bill of exchange, that is a negotiable payment obligation, of an importer to be put into subsequent use as payment for goods/services provided by an exporter. The E-DRAFT can be in digital or non-digital format. The E-DRAFT is payable at a predetermined future date. Once the instrument is executed by both the exporter signing the E-DRAFT and endorsing it to the financial organization, and by the importer accepting the E-DRAFT, it becomes a negotiable payment obligation and can be converted into cash in accordance with its terms by an owner or transferred to additional owners by subsequent endorsement.

A financing method utilizing E-DRAFT(s), in accordance with the invention employs: an exporter located in any country; an importer located in any country, a financing organization; and a participating bank appointed by the financial organization.

In order for an exporter and an importer to make use of this financing method, they must first have negotiated an agreement for the exporter to supply goods/services to the importer. Thereafter, both the exporter and the importer must apply for enrollment by the financial organization. If accepted, they are enrolled and registered by the organization. The subsequent steps by the parties are as follows.

1. The importer or the financial organization generates online transaction record with instructions to exporter that sets forth the maximum amount of the purchase, identifies the exporter, defines the time period of the transaction, the requisite shipping documents, payment terms and fees.

2. The exporter retrieves online the transaction record and accepts the instructions as set forth above from Importer.

3. The exporter having received instructions from the importer delivers goods/services to an identified facility, such as a custom agency, for subsequent delivery of goods/services to the importer.

5. The exporter generates online E-DRAFT(s) and signs the E-DRAFT(s), endorses the E-DRAFT(s) to the financial organization, prepares and signs an instruction letter containing appropriate instructions for collection of funds, and prepares shipping documents. Then the exporter forwards shipping documents, signed E-DRAFT(s) and instruction letter to the participating bank.

6 The participating bank holds the shipping documents and forwards E-DRAFT(s) to the importer for acceptance and signature.

7. The importer forwards the accepted and signed E-DRAFT(s) to the participating bank who informs the organization that the signed E-DRAFT(s) have been received.

8. The organization purchases the E-DRAFT(s) from the exporter, by forwarding the purchase cost to the participating bank or to another source, with instructions to forward these funds to the exporter.

9. After the transfer of the payment to the exporter, the participating bank sends the shipping documents to the importer for use in obtaining delivery of the goods/services from the facility.

The timing of the payment and delivery of goods steps can be varied so that these steps can be carried out simultaneously or in reverse order.

The invention will now be explained in more detail with reference to the drawings and detailed description of preferred embodiments that follow.

### BRIEF DESCRIPTION OF THE DRAWINGS

FIG. 1 is a front view of an illustrative E-DRAFT.

FIG. 2 is a rear view of the E-DRAFT of FIG. 1 after endorsement..

FIG. 3 is a diagram illustrating the enrollment process.

FIG. 4 is a diagram illustrates the steps wherein the importer generates transaction instructions online using the organization services.

FIG. 5 is a diagram illustrating the steps of generating the E-DRAFT(s), completing the process wherein the exporter is paid and the importer receives the goods.

### DETAILED DESCRIPTION OF PREFERRED EMBODIMENTS

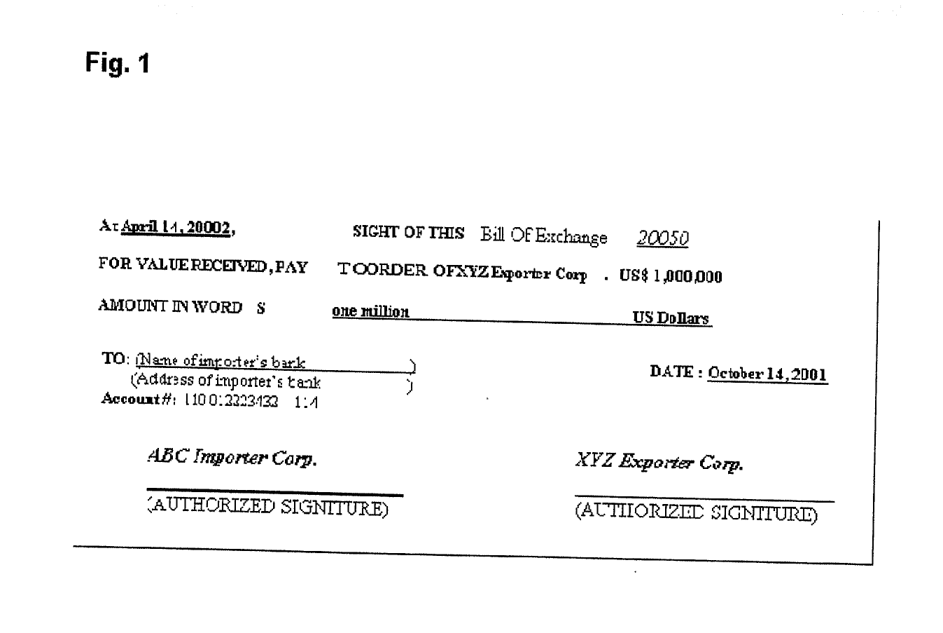

Referring first to FIG. 1, the front side of an E-DRAFT identifies exporter with signature, importer with signature, importer's bank, the date when the E-DRAFT was issued, the date at which it is due, the money value of the E-DRAFT in numbers and in letters, and is drawn to the order of the exporter.

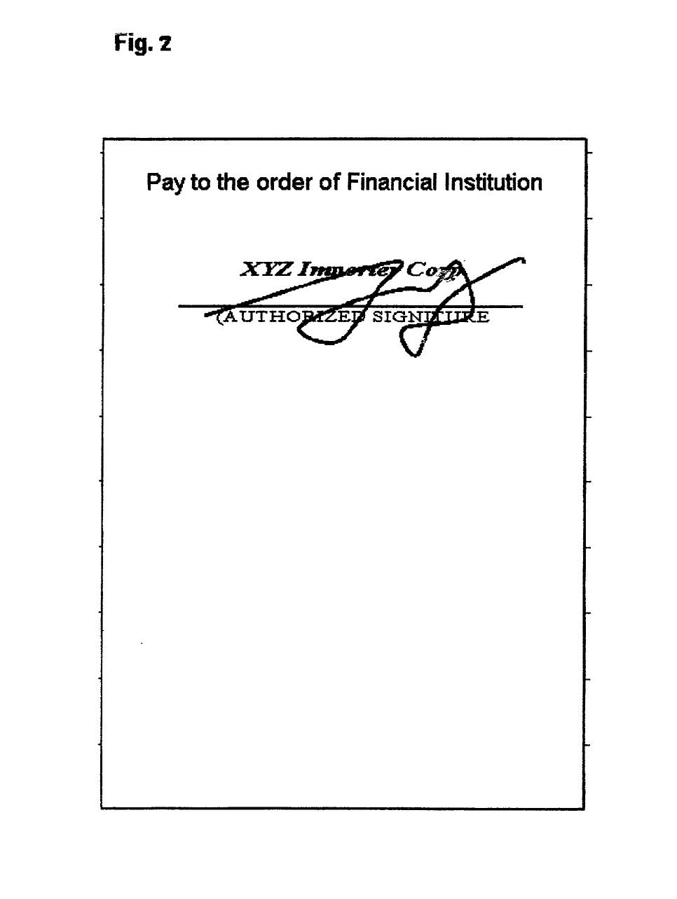

As shown in FIG. 2, the rear view displays the name and signature of the importer and the endorsement to the financial organization, this endorsement converting the E-DRAFT(s) into a payment instrument, and making the financial organization a holder in due course.

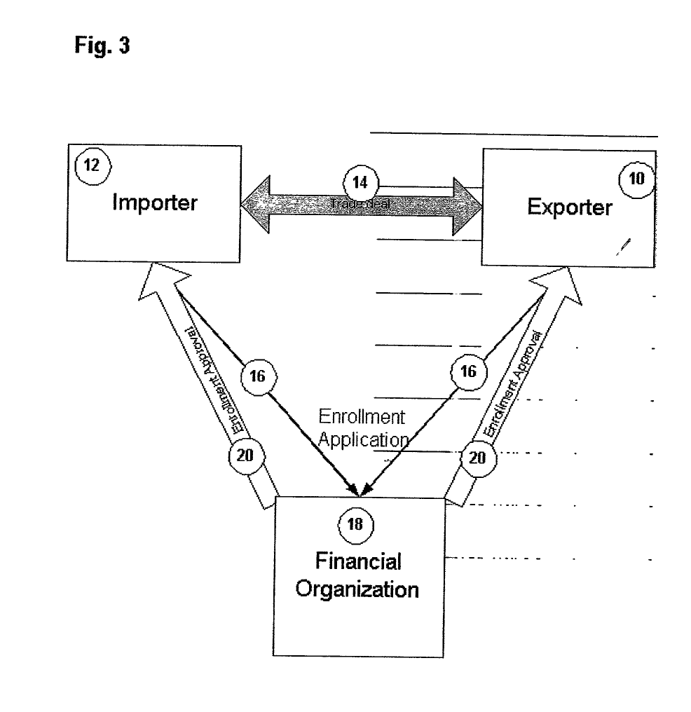

As shown in FIG. 3, importer 12 and exporter 10 negotiate an agreement 14. Both exporter and importer forward enrollment applications 16 to the financial organization 18. Importer and exporter each receive enrollment approval 16.

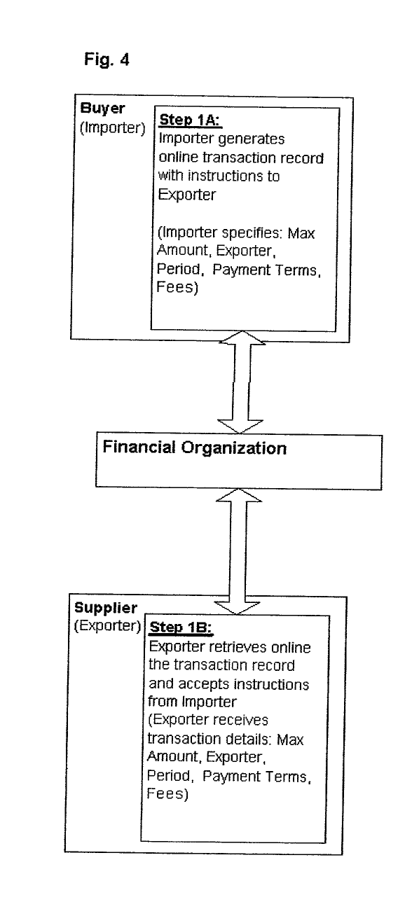

FIG. 4 illustrates the actions of the importer, using the services of the financial organization to initiate a transaction. More particularly as explained, the importer [buyer] generates an online transaction record with instructions to the exporter, identifying the maximum amount, the exporter, the period, the requested shipping documents, the payment terms and the fees to be paid to the financial organization. The record is forwarded to the financial organization. The exporter retrieves on line the transaction record and accepts the aforementioned instructions from the importer.

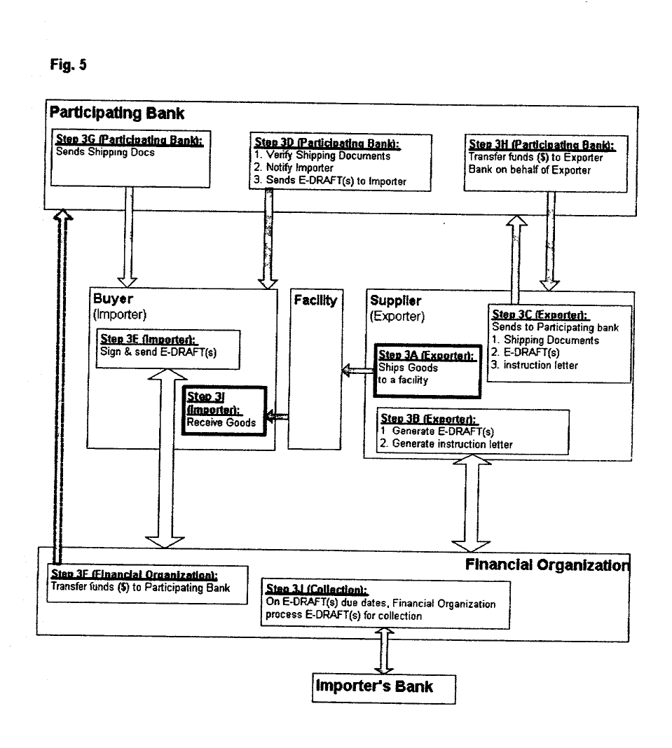

FIG. 5 is a diagram illustrating the steps of completing the process wherein the exporter is paid and the importer receives the goods. As explained in Step 3A, the exporter ships goods and or services-to a facility. The exporter generates E-DRAFT(s) and instruction letter and sends both, Step 3B, to the financial organization. The exporter, Step 3C, sends the shipping documents, instruction letter and the E-DRAFT(s) to the participating bank. This bank, Step 3D, only holds the shipping documents, notifying importer, and sends the E-DRAFT(s) to the importer. The importer, Step 3E, signs and sends E-DRAFT(s)s to the participating bank, which acts as a trustee. The organization, Step 3F, purchases the E-DRAFT(s) and transfers the purchase funds from any one of its various accounts to the participating bank or directly to the exporter and notifies the PB regarding the transfer of finds to the exporter. Upon the transfer of funds to exporter, the participating bank, Step 3G, sends the shipping documents to the importer. The participating bank, Step 3H, transfers the funds to the advising bank on behalf of the exporter The importer, Step 31, takes the shipping documents to the facility and obtains the goods in accordance with the purchase agreement. The organization, Step 3J, on E-DRAFT(s) due dates processes E-DRAFT(s) for collection of funds from the Importer's Bank While the invention has been described with particular reference to the drawings and detailed description, the protection solicited is to be limited only by the claims, which follow.

What is claimed is:

1. A financing method utilizing E-DRAFT(s), an exporter [E] located in any country, an importer [I] located in any country, a financing organization [FO], a participating bank [PB] appointed by FO, wherein E and I have negotiated an agreement for E to supply goods/services to I, which includes the steps of:
[a] E and I apply for enrollment by FO whereby they are enrolled and registered by FO, the registration including the recording of an agreement between I and FO for I to issue E-DRAFT(s) as payment for goods/services purchased from E and for FO to purchase E-DRAFT(s) from I;
[b] I generates online transaction record with instructions to E. The transaction record specifies the maximum amount, identifies the exporter, the period of the transaction, the requested shipping documents, the payment terms, and the fees.
[c] E retrieves online the transaction record and accepts instructions as set forth in step [b] above.
[d] E, having received instructions from I, delivers goods/services to an identified facility;
[e] E online generates and signs the E-DRAFT(s), endorses the E-DRAFT(s) to the FO, prepares and signs a instruction letter containing appropriate instructions to PB, and prepares shipping documents;
[g] E forwards shipping documents, signed E-DRAFT(s) and instruction letter to PB;
[h] PB forwards E-DRAFT(s) to I for acceptance and signature;
[i] I forwards accepted and signed E-DRAFT(s) to PB;
[j] FO purchases E-DRAFT(s) from E and forwards funds of purchase to PB or to another source with instructions to forward funds to E's Bank;
[k] PB sends shipping documents to I who uses same to obtain goods/services from facility.
[1] FO endorses the E-DRAFT(s), thus converting them to payment instruments, and sells the endorsed E-DRAFT(s) to another Financial Organization or alternatively, on the E-DRAFT(s) due-date, process the E-DRAFT(s) for collection of funds from the I's bank;

2. The method of claim 1 wherein steps j and k can be performed simultaneously or in opposite order.

3. The method of claim 1 wherein the facility is a customs agency.
